(19) United States
(12) Patent Application Publication
(10) Pub. No.: US 2008/0023285 A1
(43) Pub. Date: Jan. 31, 2008

(54) Control apparatus for lockup clutch

(75) Inventor: Kazutoshi Tsunekawa, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 11/878,609

(22) Filed: Jul. 25, 2007

(30) Foreign Application Priority Data
Jul. 28, 2006 (JP) 2006-206019

(51) Int. Cl. F16D 35/00; G06F 17/00

(52) U.S. Cl. 192/3.3; 701/51

(57) ABSTRACT

A lockup clutch control apparatus includes a power unit, an automatic transmission, a torque converter, a lockup clutch, an input shaft connected to the power unit, a first output shaft for transmitting the driving force to the automatic transmission; and a second output shaft for transmitting the driving force from the automatic transmission. When a power unit rotation speed or a first output shaft rotation speed becomes equal to, or lower than a first rotation speed, the lockup pressure supplied to the lockup clutch is controlled at a first pressure reduction speed to a target reduced pressure value which is obtained within a range at which the lockup pressure can be controlled. When the lockup pressure becomes the target reduced pressure value, the lockup pressure is reduced at a second pressure reduction speed, which is lower than the first pressure reduction speed, until the lockup clutch starts slipping.

### CROSS REFERENCE TO RELATED APPLICATIONS

This application is based on and claims priority under 35 U.S.C. § 119 to Japanese Patent Application 2006-206019, filed on Jul. 28, 2006, the entire content of which is incorporated herein by reference.

### FIELD OF THE INVENTION

This invention relates to a control apparatus for a lockup clutch which mechanically engages an input shaft and an output shaft of a torque converter. More particularly, this invention relates to the control apparatus for a lockup clutch which controls an engagement degree of the lockup clutch in accordance with a driving condition of a vehicle.

### BACKGROUND

A known control apparatus for a lockup clutch, which prevents an engine from stalling when the braking force operates rapidly at the engagement state of the lockup clutch, is disclosed in Japanese Patent No. 3092017 (hereinafter, referred to as a reference 1). The control apparatus for the lockup clutch releases the lockup clutch when a brake signal is detected in a situation where the lockup clutch is in the engagement state. After detecting the brake signal, the control apparatus for the lockup clutch reengages the lockup clutch only when a reduction speed of the vehicle after a predetermined time is equal to, or less than, a predetermined reduction speed. Further, JP2001-330138A (hereinafter, referred to as a reference 2) discloses a control apparatus for a lockup clutch which obtains an adequate clutch releasing speed in accordance with a driving condition of a vehicle. The control apparatus for the lockup clutch disclosed in the reference 2 determines the clutch releasing speed, which is applied during the lockup clutch is being released, by a clutch releasing speed determining means in accordance with a driving condition of a vehicle detected by a driving condition determining means. The clutch releasing speed is applied during the lockup clutch is being released.

The known control apparatus for the lockup clutch disclosed in the reference 1 rapidly releases the lockup clutch when the brake signal is detected, i.e., the brake is in “on” state. Therefore, a shock may be generated when the lockup clutch is released. For example, when a lockup clutch is engaged when a driver does not step on an accelerator pedal and when the vehicle obtains a braking force from the engine stall (exhaust brake), if the vehicle speed is reduced with a weak braking force, a releasing shock may be generated when the lockup clutch condition is altered from an “on” area, i.e., an engagement condition, to an “off” area, i.e., disengagement condition, and when the lockup clutch is rapidly released. Further, by rapidly releasing the lockup clutch, an operator (in this case, a driver) may obtain a less vehicle speed reduction feeling and a vehicle idling. In such circumstances, the driver may furthermore tread on the brake pedal, thus worsening a driving operability.

The known control apparatus for the lockup clutch disclosed in the reference 2 determines the clutch releasing speed, which is applied during the lockup clutch is in released condition, in accordance with a speed reducing condition of the vehicle, detected by a driving condition detecting means, and accelerates the clutch releasing speed when the speed reduction of the vehicle is large. Therefore, the releasing shock may be generated and a rotation number of the engine may rapidly rise (high rpm idling). For example, when the driving load is heavy such as when a large vehicle with a large amount of luggage is driving a slope uphill, the driving speed may be reduced regardless of the driver stepping on the accelerator. As a consequence of the speed reduction, the lockup clutch condition is altered from “on” area to “off” area and the lock up clutch is rapidly released. Accordingly, the releasing shock and high rpm idling is generated and then, the driving operability may be worsened.

A need exists for a lockup clutch mechanism which is not susceptible to the drawback mentioned above.

### SUMMARY OF THE INVENTION

According to an aspect of the present invention, a lockup clutch control apparatus includes a power unit, an automatic transmission for transmitting a driving force generated by the power unit, and a torque converter which is arranged between the power unit and the automatic transmission. The lockup clutch control apparatus further includes an input shaft which is connected to the power unit for transmitting the driving force from the power unit to the torque converter, a first output shaft which is connected to the automatic transmission for transmitting the driving force from the power unit to the automatic transmission via the torque converter, a second output shaft which is connected to the automatic transmission for transmitting the driving force from the automatic transmission; and a lockup clutch which is arranged with the torque converter and is shifted between a fully engaged state and a disengaged state. The lockup clutch control apparatus is characterized in that the lockup pressure supplied to the lockup clutch is controlled at a first pressure reduction speed to a target reduced pressure value where the lockup clutch still maintains an engaging state upon the lockup clutch being shifted from the fully engaged state to the disengaged state when a power unit rotation speed or a first output shaft rotation speed is equal to, or lower than a first rotation speed.

### BRIEF DESCRIPTION OF THE DRAWINGS

The foregoing and additional features and characteristics of the present invention will become more apparent from following detailed description considered with reference to the accompanying drawings, wherein;

FIG. 1 is a schematic view illustrating a structure of a vehicle including a lockup clutch control apparatus;

FIG. 2 is a sectional view schematically illustrating a structure of the lockup clutch mechanism;

FIG. 3 is a schematic view of an oil pressure circuit of a lock up clutch control circuit;

FIG. 4 is a flowchart schematically explaining the operation of the lockup clutch control apparatus according to the first embodiment of the present invention;

FIG. 5 is a graph schematically illustrating a case (Case 1) of the operation of the control apparatus of the lockup clutch according to the first embodiment of the present invention;

FIG. 6 is a graph schematically illustrating another case (Case 2) of the operation of the control apparatus of the lockup clutch according to the first embodiment of the present invention;

FIG. 7 is a graph schematically illustrating still another case (Case 3) of the operation of the control apparatus of the lockup clutch according to the first embodiment of the present invention; and

FIG. 8 is a graph schematically illustrating still another case (Case 4) of the operation of the control apparatus of the lockup clutch according to the first embodiment of the present invention.

### DETAILED DESCRIPTION

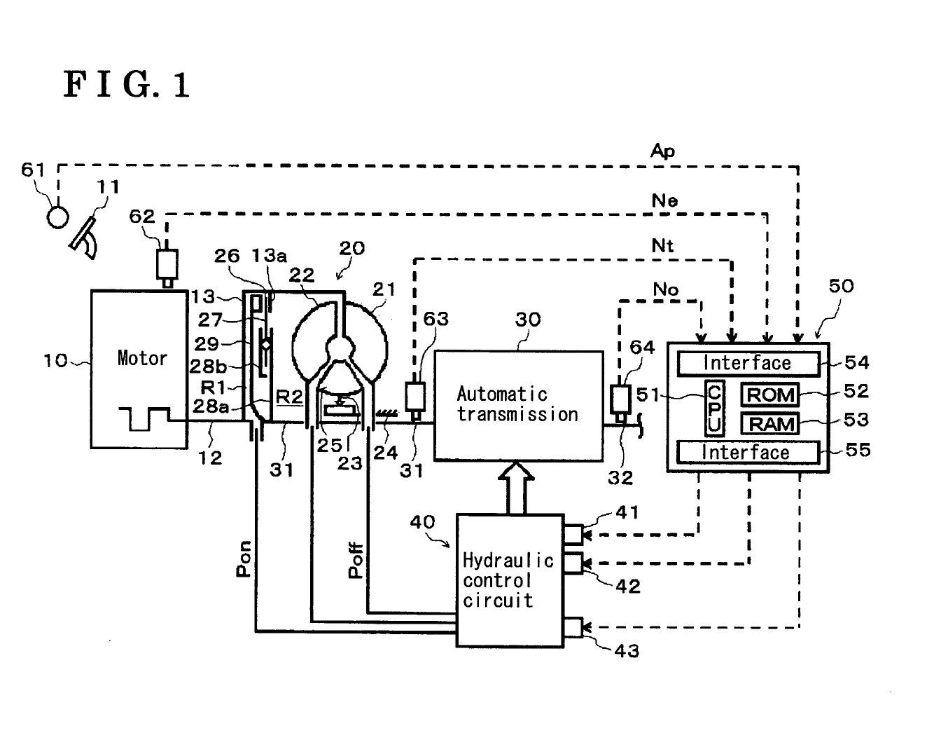

A first embodiment of the present invention will be explained in accordance with attached drawings. FIG. 1 is a schematic view illustrating a structure of a vehicle including a lockup clutch control apparatus.

As shown in FIG. 1, a vehicle includes a power unit 10, a torque converter 20, an automatic transmission 30, a hydraulic control circuit 40, and an electronic control unit 50.

For example, the power unit 10 is represented by an engine, a motor, a hybrid engine, or the like. An amount of output of the power unit 10 is adjusted (increased or decreased) by an operation of an accelerator pedal 11. The output of the power unit 10 is transmitted to the torque converter 20, the automatic transmission 30, and to non-illustrated driving wheels via a differential gear, which is not illustrated either.

The torque converter 20 is mainly configured with a fluid-type transmitting mechanism and a lockup clutch mechanism. The fluid-type transmitting mechanism includes a pump impeller 21, a turbine runner 22, and a stator 25. The pump impeller 21 is connected to a rotating shaft 12 (serving as an input shaft of the torque converter, connected to the power unit) of the power unit 10 via a connecting member 13, which includes components such as a front cover of the torque converter 20. The turbine runner 22 is fixedly attached to a first output shaft 31 (serving as an output shaft of the torque converter connected to the automatic transmission 30, i.e., an input shaft of the automatic transmission 30) of the automatic transmission 30 and rotates by oil pressure transferred from the pump impeller 21. The stator 25 is fixedly attached to a housing 24 via a one-way clutch 23. The lockup clutch mechanism is connected to the fluid-type transmitting mechanism and is arranged in parallel thereto. The lockup clutch mechanism will be described in detail later.

The automatic transmission 30 includes the first output shaft 31, which is connected to the torque converter 20, and a second output shaft 32. In the automatic transmission 30, multiple shift stages are established in accordance with a combination of engagement and disengagement of multiple frictional engagement elements. The second output shaft 32 is connected to driving wheels (not illustrated) via components such as a differential gear (not illustrated).

The hydraulic control circuit 40 controls oil pressure supplied to the automatic transmission 30 and to the lockup clutch mechanism. The hydraulic control circuit 40 is provided with a first solenoid valve 41, a second solenoid valve 42 and a third solenoid valve 43, each of which receives a signal of the electronic control unit 50 and is turned on and off. The first solenoid valve 41 and the second solenoid valve 42, of the hydraulic control circuit 40, are configured to selectively control the frictional engagement elements of the automatic transmission 30 to be engaged or to be released (disengaged) at a predetermined pressure level. The third solenoid valve 43 is configured to control the lockup clutch 26 to be engaged or to be released (disengaged) and to adjust oil pressures “Pon” and “Poff”, which are respectively supplied to a clutch-engagement oil chamber R1 and to a clutch-disengagement oil chamber R2. The third solenoid valve 43 may be represented by a valve that is electrically driven by a solenoid. The valve, which is driven by a solenoid, controls a duty ratio in terms of a signal of the electronic control unit 50. A duty ratio herein corresponds to a ratio of an ON time, in which the solenoid is electrically energized, and an OFF time, in which the solenoid is not electrically energized. The third solenoid valve 43 controls a line pressure via a lockup-pressure control valve, and supplies a control oil pressure to the clutch-engagement oil chamber R1. The third solenoid valve 43 further supplies a fixed amount of oil pressure to the clutch-disengagement oil chamber R2 from the hydraulic control circuit 40 when being duty-controlled. When not being duty-controlled, the third solenoid valve 43 supplies drain pressure to the clutch-disengagement oil chamber R2 from the hydraulic control circuit 40. As described above, the third solenoid valve 43 adjusts an engagement pressure applied to the lockup clutch 26.

The electronic control unit 50 is electrically connected to an accelerator opening degree sensor 61, a power unit rotation speed sensor 62, a first output shaft rotation speed sensor 63, and a second output shaft rotation speed sensor 64. The accelerator opening degree sensor 61 detects an accelerator opening degree Ap of the accelerator pedal 11. The power unit rotation speed sensor 62 detects a rotation speed Ne of the power unit 10 (a power unit rotation speed Ne). The first output shaft rotation speed sensor 63 detects a rotation speed Nt of the first output shaft 31 of the automatic transmission 30 (a first output rotation speed Nt). The second output shaft rotation speed sensor 64 detects a rotation speed No of the second output shaft 32 of the automatic transmission 30 (a second output rotation speed No). A signal exhibiting the accelerator opening degree Ap, a signal exhibiting the power unit rotation speed Ne (corresponding to a rotation speed of the pump impeller 21), a signal exhibiting the first output shaft rotation speed Nt (corresponding to a rotation speed of the turbine runner 22), and a signal exhibiting the second output shaft rotation speed No are inputted via an interface 54 to the electronic control unit 50.

The electronic control unit 50 includes a CPU 51, a ROM52, a RAM 53 and interfaces 54, 55. The CPU 51 processes each inputted signal in accordance with the programs and databases (maps) stored in the ROM 52. The CPU 51 also sends signals to drive and control the first to third solenoid valves 41, 42, 43 via the interface 55, by using the RAM 53 as required, in order to implement the gear change control for the automatic transmission 30 and the engagement control for the lockup clutch 26. In the ROM 52, a return-pressure map, an operational range map for the lockup clutch mechanism, and other maps for obtaining transfer capacities, such as lockup pressure map at gear changing and at starting slip control, are stored. The electronic control unit 50 serves as a control unit for the lockup clutch.

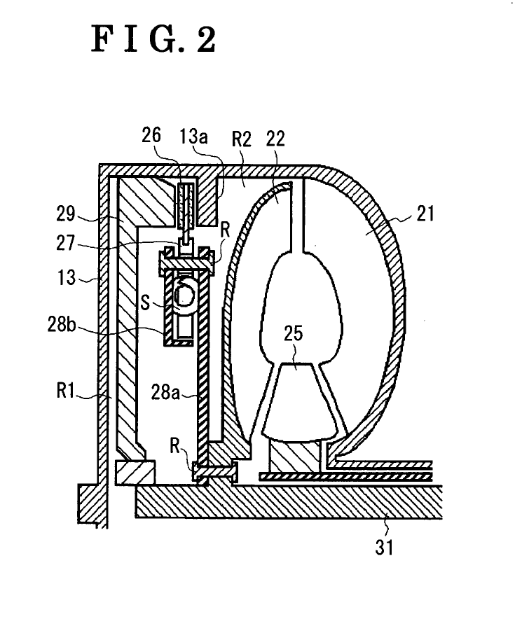

The structure of the lockup clutch mechanism will be explained hereinbelow. FIG. 2 is a sectional view schematically illustrating the structure of the lockup clutch mechanism.

With reference to FIG. 2, the lockup clutch mechanism is structured with a lockup clutch 26, a drive plate 27, a clutch facing portion 13a, a first driven plate 28a, a second driven plate 28b, a lockup piston 29, and coil springs S.

The lockup clutch 26 is a ring-shaped plate, which is provided with frictional materials at both surfaces thereof and is movably supported in an axial direction. The drive plate 27 is a ring-shaped plate fixedly attached to a radially inward of the lockup clutch 26 and axially movably arranged between the first driven plate 28a and the second driven plate 28b. The clutch facing portion 13a is integrally structured with a connecting member 13 so as to face one surface of the lockup clutch 26. The first driven plate 28a is fixedly attached to the first output shaft 31 via rivets R so as to integrally rotate with the first output shaft 31, while the second driven plate 28b is a ring-shaped plate fixedly attached to the first driven plate 28a via rivets R. The coil springs S are damper structures which are configured to absorb vibrations between the drive plate 27 and the first and second driven plate 28a, 28b. The coil springs S are housed in window portions formed at the first and second driven plate 28a and 28b and arranged in a circumferential direction thereof. Accordingly, the coil springs S applies an elastic force between the drive plate 27 and the first driven plate 28 when a twisted angle is generated therebetween.

The lockup piston 29 is a ring-shaped piston which exerts pressure to the lockup clutch 26 towards the clutch facing portion 13a and which is axially movable by oil pressure flowing into the clutch-engagement oil chamber R1. When the oil pressure in the clutch-engagement oil chamber R1, which is defined by the lockup piston 29 and the connecting member 13, is higher than the oil pressure in the clutch-disengagement oil chamber R2, which is defined by the lockup clutch 26, the clutch facing portion 13a and the first driven plate 28a, the lockup piston 29 exerts pressure in a direction of the clutch facing portion 13a in order to engage the lockup clutch 26 with the clutch facing portion 13a. On the other hand, when the oil pressure in the clutch-disengagement oil chamber R2 is higher than the oil pressure in the clutch-engagement oil chamber R1, the lockup piston 29 is operated in a manner where the lockup clutch 26 is separated from the clutch facing portion 13a, i.e., the lockup clutch 26 and the clutch facing portion 13a are disengaged from each other.

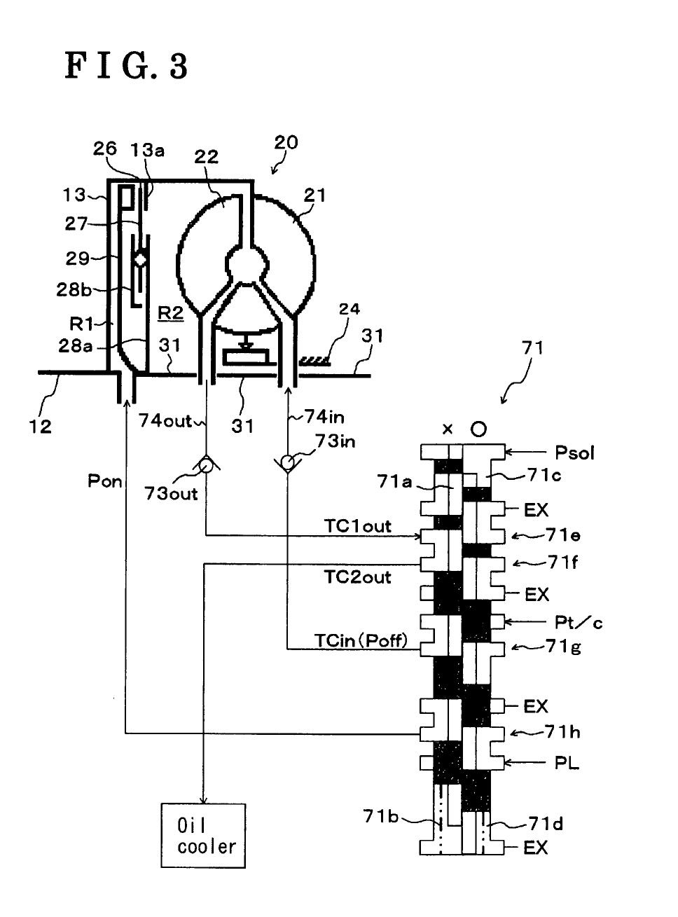

Next, a lockup control circuit of the hydraulic control circuit is explained hereinbelow with drawings. FIG. 3 is a schematic view of an oil pressure circuit of the lock up clutch control circuit.

As described in FIG. 3, a valve 71 is a selector valve which selectively changes an oil passage and includes a spool 71a, a spring 71b, a first oil pressure chamber 71c and a second oil pressure chamber 71d. The spool 71a is slidably provided in the valve body (not illustrated). The spring 71b is provided in the second oil pressure chamber 71d and biases the spool 71a towards the first oil pressure chamber 71c, i.e., upwardly in FIG. 3. When a control pressure “Psol” from an ON-OFF solenoid (not illustrated) is introduced to the first oil pressure chamber 71c, the spool 71a is operated to slide towards the second oil pressure chamber 71d, i.e, downwardly in FIG. 3. The second oil pressure chamber 71d leads to an exhaust port (exit circuit; EX) therethrough. When the pressure in the first oil pressure chamber 71c is higher than the biasing force of the spring 71b, the spool 71a slides toward the second oil pressure chamber 71d (assigned “◯”), while, when the oil pressure in the first oil pressure chamber 71c is lower than the biasing force of the spring 71b, the spool 71a slides toward the first oil pressure chamber 71c (assigned “x”). The valve 71 includes a first switching circuit 71e which alters an oil passage. When the spool 71a of the valve 71 is positioned as illustrated by “x” in FIG. 3, the first switching circuit 71e establishes an oil passage for returning a return pressure TC1out from the torque converter to an oil cooler via a torque converter oil-draining passage 74out and a check valve 73out (one-way valve). On the other hand, when the spool 71a of the valve 71 is positioned as illustrated by “◯” in FIG. 3, the first switching circuit 71e establishes an oil passage for draining the return pressure TC1out to the exhaust port (EX). The valve 71 further includes a second switching circuit 71f which alters an oil passage. When the spool 71a of the valve 71 is positioned as illustrated by “x” in FIG. 3, the second switching circuit 71f establishes an oil passage for returning the return passage TC1out from the torque converter to the oil cooler via the torque converter oil-draining passage 74out and the check valve 73out (one-way valve). On the other hand, when the spool 71a of the valve 71 is positioned as illustrated by “◯” in FIG. 3, the second switching circuit 71f establishes an oil passage for connecting the oil cooler to the exhaust port (EX). The valve 71 further includes a third switching circuit 71g which alters an oil passage. When the spool 71a of the valve 71 is positioned as illustrated by “x” in FIG. 3, the third switching circuit 71g establishes an oil passage for outputting an oil pressure input source Pt/c as an input pressure TCin (corresponding to Poff in FIG. 1) towards the torque converter via a check valve 73 in (one-way valve). Here, Pt/c is assigned as an oil pressure input source to the torque converter. On the other hand, when the spool 71a of the valve 71 is positioned as illustrated by “◯” in FIG. 3, the third switching circuit 71g establishes an oil passage for shutting off the oil pressure input source Pt/c with the check valve 73 in (one-way valve) and a torque converter oil-introducing passage 74 in. The valve 71 further includes a fourth switching circuit 71h which alters an oil passage. When the spool 71a of the valve 71 is positioned as illustrated by “x” in FIG. 3, the fourth switching circuit 71h establishes an oil passage for connecting the clutch-engagement oil chamber R1 to the exhaust port (EX). On the other hand, when the spool 71c of the valve 71 is positioned as illustrated by “◯” in FIG. 3, the fourth switching circuit 71h establishes an oil passage for supplying a line pressure PL to the clutch-engagement oil chamber R1.

When the spool 71a of the valve 71 is positioned as illustrated by “x” in FIG. 3, i.e., when a lockup pressure “Pon” is not outputted or applied to the lockup clutch 26, the return pressure TC1out returns from the torque converter through a port within the valve 71 and (TC1out) is drained to the oil cooler as an exhaust pressure TC2out. On the other hand, when the spool 71c of the valve 71 is positioned as illustrated by “0” in FIG. 3, i.e., when the lockup pressure “Pon” is outputted or applied to the lockup clutch 26, the return pressure TC1out from the torque converter is drained via the exhaust port EX. Therefore, when the lockup clutch is operated, i.e., when the lockup pressure “Pon” is outputted, the output force from the clutch-disengagement oil chamber R2 is lowered and the pressure level of the clutch-disengagement oil chamber R2 fluctuates at the minimum level possible. In order to obtain a desirable amount of the lockup pressure “Pon”, the control pressure “Psol” may be obtained, which exerts for the spool 71a with adequate balance and may be supplied to the first oil pressure chamber 71c.

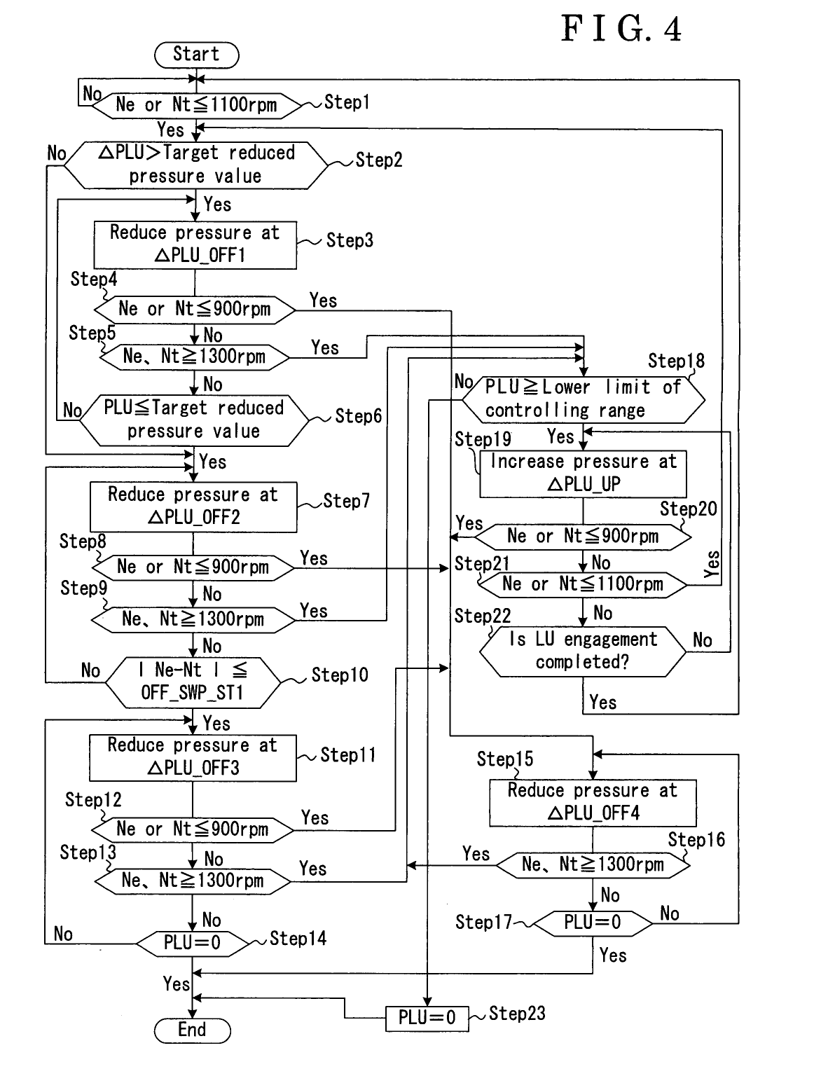

Next, an operation of the lockup clutch control apparatus (electronic control unit) according to the first embodiment of the present invention is described hereinbelow with attached drawing. FIG. 4 is a flowchart schematically explaining the operation of the lockup clutch control apparatus according to the first embodiment of the present invention.

First, when the lockup clutch 26 is in the “on” state, i.e., the lockup clutch maintains an engaging state upon the lockup clutch being shifted from the fully engaged state to the disengaged state, the electronic control unit (denoted by 50 in FIG. 1) confirms whether or not the power unit rotation speed Ne and the first output shaft rotation speed Nt are each equal to, or less than, a first rotation speed (step 1). The first rotation speed is assigned hereinbelow as 1100 rpm, for example. In a case where each rotation speed Ne and Nt exceeds 1100 rpm, an operation program of the lockup clutch returns to start from step 1. On the other hand, in a case where the rotation speeds Ne or Nt are equal to, or less than 1100 rpm, the operation program of the lockup clutch proceeds to step 2. The first rotation speed is determined in accordance with the characteristics of the power unit 10.

In the case where the rotation speed Ne or Nt is equal to 1100 rpm or therebelow, (“YES” in Step 1 or “YES” in Step 21 in FIG. 4), the electronic control unit (no. 50 in FIG. 1) confirms whether or not the lockup pressure PLU (corresponding to “Pon” in FIG. 1) is higher than a target reduced pressure value (Step 2). In a case where the lockup pressure PLU is equal to, or less than, the target reduced pressure value (“NO” in Step 2), the operation program proceeds to Step 7. On the opposite case, i.e., when the lockup pressure PLU is higher than the target reduced pressure value, the operation proceeds to Step 3. The target reduced pressure value is a predetermined pressure value which is obtained within a range at which the lockup pressure PLU can be controlled.

In the case where the lockup pressure PLU is higher than the target reduced pressure value (“YES” in Step 2 or “NO” in Step 6), the electronic control unit (no. 50 in FIG. 1) reduces the lockup pressure PLU (corresponding to “Pon” in FIG. 1) at a first pressure reduction speed ΔPLU_OFF1 (Step 3). The first pressure reduction speed ΔPLU_OFF1 is a speed level to reduce the lockup pressure PLU to the target reduced pressure value.

After Step 3, the electronic control unit (no. 50 in FIG. 1) confirms whether or not each rotation speed Ne and Nt is equal to, or less than, a second rotation speed (Step 4). The second rotation speed is assigned hereinbelow as 900 rpm, for example. In a case where each rotation speed Ne or Nt exceeds 900 rpm (“NO” in Step 4), the operation program proceeds to Step 5. On the contrary, in a case where the rotation speed Ne or Nt is equal to 900 rpm or therebelow (“YES” in Step 4), the operation program proceeds to Step 15. The second rotation speed is determined to be lower than the first rotation speed in Step 1 and is employed in a possible case where a driver suddenly steps on a brake.

In a case where each rotation speed Ne and Nt exceeds 900 rpm (“NO” in Step 4), the electronic control unit (no. 50 in FIG. 1) confirms whether or not each rotation speed Ne and Nt is equal to, or exceeds, a third rotation speed (Step 5). The third rotation speed is a predetermined rotation speed and is assigned hereinbelow as 1300 rpm, for example. In a case where the rotation speed Ne or Nt is lower than 1300 rpm (“NO” in Step 5), the operation program proceeds to Step 6. Meanwhile, in a case where each rotation speed Ne and Nt is equal to, or greater than, 1300 rpm (“YES” in Step 5), the operation proceeds to Step 18. The third rotation speed is determined higher than the first rotation speed and is employed in a possible case where a driver steps on an accelerator.

In a case where the rotation speed Ne or Nt is lower than 1300 rpm (“NO” in Step 5), the electronic control unit (no. 50 in FIG. 1) confirms whether or not the lockup pressure PLU (corresponding to “Pon” in FIG. 1) is equal to, or less than, the target reduced pressure value (Step 6). When the lockup pressure PLU is equal to the target reduced pressure value or therebelow (“YES” in Step 6), the operation program proceeds to Step 7. When the lockup pressure PLU exceeds the target reduced pressure value, the program returns to Step 3. The target reduced pressure value is a predetermined pressure value which is obtained within a range at which the lockup pressure PLU can be controlled, in the same manner as in Step 2.

In a case where the lockup pressure PLU is equal to, or less than, the target reduced pressure value (“NO” in Step 2 or “YES” in Step 6), or, an absolute rotational difference, which is assigned as |Ne−Nt|, of the rotation speeds Ne and Nt, is equal to, or exceeds, a predetermined rotational difference OFF_SWP_ST1 (“NO” in Step 10), the electronic control unit (no. 50 in FIG. 1) reduces the lockup pressure PLU at a second pressure reduction speed ΔPLU_OFF2 (Step 7). The second pressure reduction speed ΔPLU_OFF2 is a speed level, at which the electronic control unit reduces the lockup pressure PLU when the lockup pressure PLU is smaller than the target reduced pressure value and when a rotational difference between Ne and Nt is equal to, or smaller than, a predetermined rotational speed difference OFF_WAP_ST1. The second pressure reduction speed ΔPLU_OFF2 is set slower than the first pressure reduction speed ΔPLU_OFF1.

After Step 7, the electronic control unit (no. 50 in FIG. 1) confirms whether or not each rotation speed Ne and Nt is equal to, or less than, the second rotation speed. The second rotation speed here is assigned 900 rpm, for example, in the same manner as in Step 4. When each rotation speed Ne and Nt exceeds 900 rpm (“NO” in Step 8), the operation program proceeds to Step 9. On the other hand, when the rotation speed Ne or Nt is equal to 900 rpm or therebelow, the operation program proceeds to Step 15. The second rotation speed is determined lower than the first rotation speed in Step 1 and is employed in a possible case where a driver suddenly steps on a brake in the same manner as in the second rotation speed in Step 4.

When each rotation speed Ne and Nt exceeds 900 rpm (“NO” in Step 8), the electronic control unit (no. 50 in FIG. 1) confirms whether or not each rotation speed Ne and Nt is equal to, or exceeds, the third rotation speed (Step 9). The third rotation speed here is assigned 1300 rpm, for example, in the same manner as in Step 5. When the rotation speed Ne or Nt is lower than 1300 rpm (“NO” in Step 9), the operation program proceeds to Step 10. On the other hand, when each rotation speed Ne and Nt is equal to, or greater than, 1300 rpm (“YES” in Step 9), the operation program proceeds to Step 18. The third rotation speed here is determined higher than the first rotation speed in Step 1 and is employed in a possible case where a driver steps on an accelerator in the same manner as in Step 5.

When the rotation speed Ne or Nt is lower than 1300 rpm (“NO” in Step 9), the electronic control unit (no. 50 in FIG. 1) confirms whether or not an absolute rotational difference, which is assigned as |Ne−Nt|, of the rotation speeds Ne and Nt, is equal to, or exceeds, the predetermined rotational difference OFF_SWP_ST1 (Step 10). When the absolute rotational difference |Ne−Nt| is equal to, or greater than, the predetermined rotational difference OFF_SWP_ST1 (“YES” in Step 10), the operation program proceeds to Step 11. On the other hand, when the absolute rotational difference |Ne−Nt| is smaller than the predetermined rotational difference OFF_SWP_ST1, the operation program returns to Step 7. Here, when the absolute rotational difference |Ne−Nt| arrives at the predetermined rotational difference OFF_SWP_ST1, the electronic control unit detects that the lockup clutch starts slipping and an oil pressure reduction gradient is changed.

When the absolute rotational difference |Ne−Nt| is equal to, or exceeds, the predetermined rotational difference OFF_SWP_ST1 (“YES” in Step 10), or, lockup pressure PLU is not equal to zero, (“NO” in Step 14), the electronic control unit (no. 50 in FIG. 1) reduces the lockup pressure PLU at a third pressure reduction speed ΔPLU_OFF3 (Step 11). The third pressure reduction speed ΔPLU_OFF3 is a speed level at which the electronic control unit reduces the lockup pressure when the absolute rotational difference |Ne−Nt| is equal to, or exceeds, the predetermined rotational difference OFF_SWP_ST1 and is determined slower than the second pressure reduction speed APLU_OFF2 in Step 7.

After Step 11, the electronic control unit (no. 50 in FIG. 1) confirms whether or not each rotation speed Ne and Nt is equal to, or less than the second rotation speed (Step 12). The second rotation speed is assigned as 900 rpm, for example, in the same manner as in Step 4 and Step 8. When each rotation speed Ne and Nt exceeds 900 rpm (“NO” in Step 12), the operation program proceeds to Step 13. On the other hand, when the rotation speed Ne or Nt is equal to 900 rpm or therebelow (“YES” in Step 12), the operation program proceeds to Step 15. The second rotation speed here is determined lower than the first rotation speed in Step 1 and is employed in a possible case where a driver suddenly steps on a brake in the same manner as in the second rotation speed in Step 4 and Step 8.

When each rotation speed Ne and Nt exceeds 900 rpm (“NO” in Step 12), the electronic control unit (no. 50 in FIG. 1) confirms whether or not each rotation speed Ne and Nt is equal to, or exceeds, the third rotation speed (Step 13). The third rotation speed here is assigned 1300 rpm, for example, in the same manner as in Step 5 and Step 9. When the rotation speed Ne or Nt is lower than 1300 rpm (“NO” in Step 13), the operation program proceeds to Step 14. On the other hand, when each rotation speed Ne and Nt is equal to, or greater than, 1300 rpm (“YES” in Step 13), the program proceeds to Step 18. The third rotation speed here is determined higher than the first rotation speed in Step 1 and is employed in a possible case where a driver steps on an accelerator in the same manner as in Step 5 and Step 9.

When the rotation speed Ne or Nt is lower than 1300 rpm (“NO” in Step 13), the electronic control unit (no. 50 in FIG. 1) confirms whether or not the lockup pressure PLU (corresponding to “Pon” in FIG. 1) is equal to zero (Step 14). When the lockup pressure PLU is equal to zero, i.e., when the lockup clutch is in a fully disengaged state (“YES” in Step 14), the operation program ends thereat. On the other hand, when the lockup pressure PLU is not equal to zero (“NO” in Step 14), the operation program returns to Step 11.

When the rotation speed Ne or Nt is equal to 900 rpm or therebelow (“YES” in Step 4, Step 8, Step 12, and in Step 20), or, when the lockup pressure PLU is not equal to zero (“NO” in Step 17), the electronic control unit (no. 50 in FIG. 1) reduces the lockup pressure (corresponding to “Pon” in FIG. 1) at a fourth oil pressure reduction speed ΔPLU_OFF4 (Step 15). The fourth pressure reduction speed ΔPLU_OFF4 is a speed level at which the electronic control unit reduces the lockup pressure when the rotation speed Ne or Nt is equal to, or less than, 900 rpm and is faster than the first pressure reduction speed ΔPLU_OFF1. The fourth pressure reduction speed is assigned when a driver suddenly steps on a brake.

After Step 15, the electronic control unit (no. 50 in FIG. 1) confirms whether or not each rotation speed Ne and Nt is equal to, or exceed, the third rotation speed (Step 16). The third rotation speed here is assigned 1300 rpm, for example, in the same manner as in Steps 5, 9 and 13. When the rotation speed Ne or Nt is lower than 1300 rpm (“NO” in Step 16), the operation program proceeds to Step 18. The third rotation speed here is determined higher than the first rotation speed in Step 1 and is employed in a possible case where a driver steps on an accelerator in the same manner as in Steps 5, 9, and 13.

When the rotation speed Ne or Nt is lower than 1300 rpm (“NO” in Step 16), the electronic control unit (no. 50 in FIG. 1) confirms whether or not the lockup pressure PLU (corresponding to “Pon” in FIG. 1) is equal to zero (Step 17). When the lockup pressure PLU is equal to zero (“YES” in Step 17), the operation program ends thereat. On the other hand, when the lockup pressure PLU is not equal to zero (“NO” in Step 17), the operation program returns to Step 15.

When each rotation speed Ne and Nt is equal to, or exceeds, 1300 rpm (“YES” in Step 5, 9, 13 and 16), the electronic control unit (no. 50 in FIG. 1) confirms whether or not the lockup pressure PLU (corresponding to “Pon” in FIG. 1) is equal to, or exceeds, the lower limit of a range at which the lockup pressure PLU can be controlled (Step 18). When the lockup pressure PLU is equal to, or exceeds the lower limit of the range at which the lockup pressure PLU can be controlled (“YES” in Step 18), the operation program proceeds to Step 23. On the other hand, when the lockup pressure PLU is less than the lower limit of the range at which the lockup pressure PLU can be controlled (“NO” in Step 18), the operation program ends thereat.

When the lockup pressure PLU is equal to, or exceeds the lower limit of the range at which the lockup pressure PLU can be controlled (“YES” in Step 18), or when an engagement of the lockup clutch is not completed (“NO” in Step 22), the electronic control unit (no. 50 in FIG. 1) increases the lockup pressure PLU (corresponding to “Pon” in FIG. 1) at an intensified pressure speed ΔPLU_UP (Step 19).

After Step 19, the electronic control unit (no. 50 in FIG. 1) confirms whether or not each rotation speed Ne and Nt is equal to, or less than, the second rotation speed (Step 20). The second rotation speed here is assigned as 900 rpm, for example, in the same manner as in Steps 4, 8, and 12. When each rotation speed Ne and Nt exceeds 900 rpm (“NO” in Step 20), the operation program proceeds to Step 21. On the other hand, when the rotation speed Ne or Nt is equal to 900 rpm or therebelow (“YES” in Step 20), the operation program proceeds to Step 15. The second rotation speed here is determined lower than the first rotation speed in Step 1 and is employed in a possible case where a driver suddenly steps on a brake in the same manner as in the second rotation speed in Steps 4, 8 and 12.

When each rotation speed Ne and Nt exceeds 900 rpm (“NO” in Step 20), the electronic control unit (no. 50 in FIG. 1) confirms whether or not each rotation speed Ne and Nt is equal to, or less than, the first rotation speed (Step 21). The first rotation speed here is assigned as 1100 rpm, for example, in the same manner as in Step 1. When each rotation speed Ne and Nt exceeds 1100 rpm (“NO” in Step 21), the operation program proceeds to Step 22. On the other hand, when the rotation speed Ne or Nt is equal to 1100 rpm or therebelow (“YES” in Step 21), the operation program proceeds to Step 2. First rotation speed here is determined in accordance with the characteristic of power unit 10 in the same manner as in Step 1.

When each rotation speed Ne and Nt exceeds 1100 rpm (“NO” in Step 21), the electronic control unit (no. 50 in FIG. 1) confirms whether or not the engagement of the lockup clutch is completed (Step 22). When the engagement of the lockup clutch is completed (“YES” in Step 22), the operation program returns to Step 1. On the other hand, when the engagement of the lockup clutch is completed (“NO” in Step 22), the operation program returns to Step 19.

When the lockup pressure PLU is equal to, or exceeds the lower limit of the range at which the lockup pressure PLU can be controlled (“YES” in Step 18), the electronic control unit (no. 50 in FIG. 1) continues to reduce the lockup pressure PLU until the lockup pressure reaches zero. The pressure reduction speed is not altered here. When the lockup pressure PLU reaches zero, the operation program ends thereat.

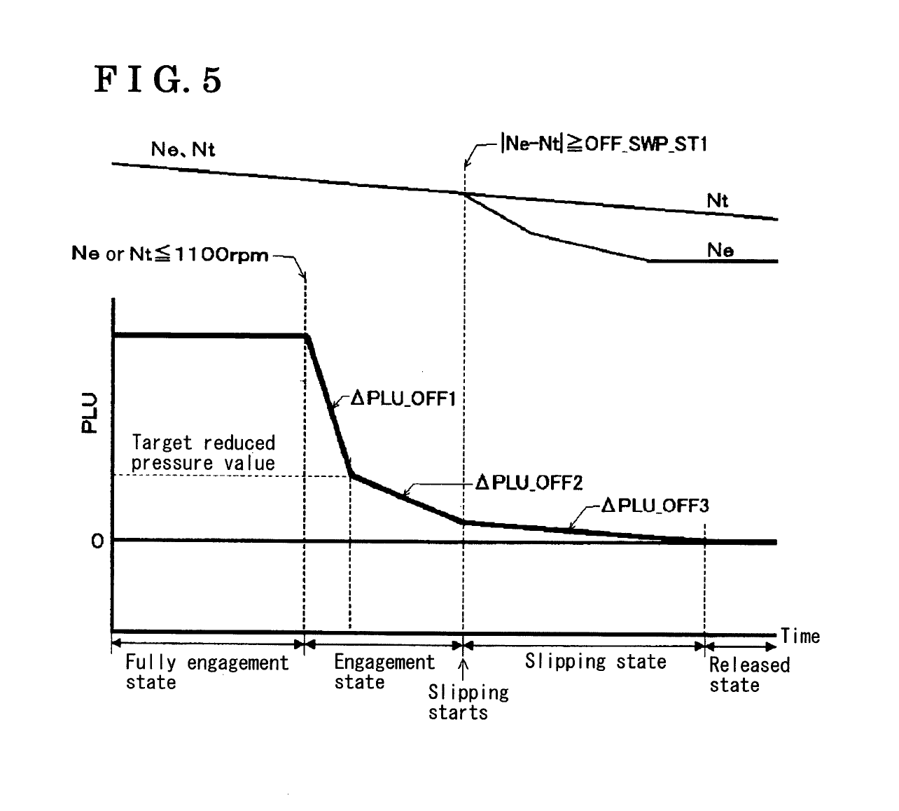

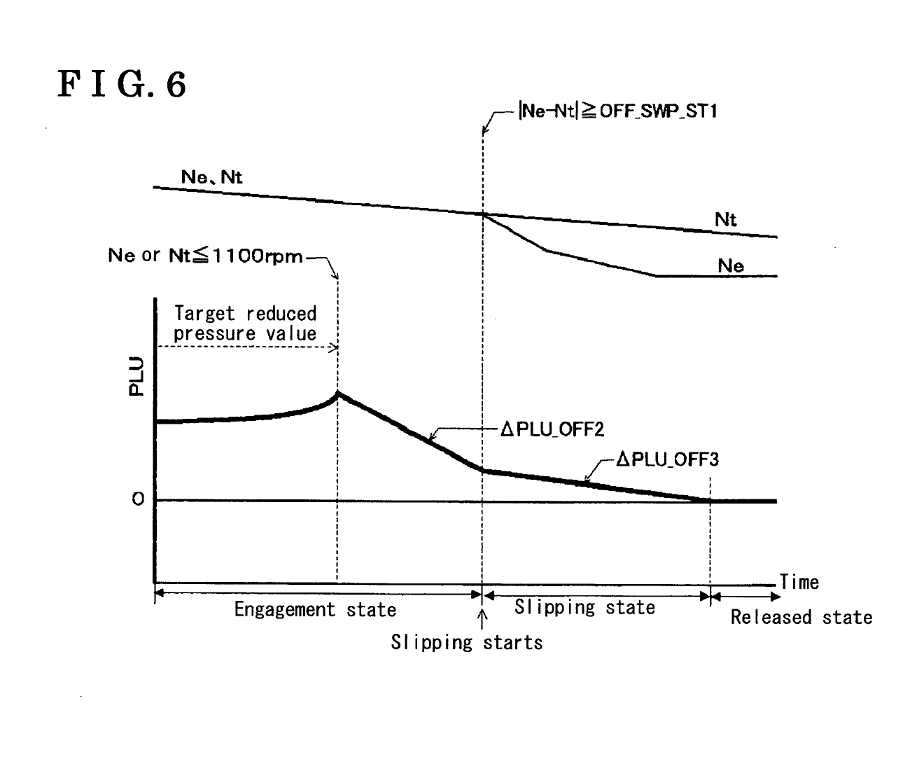

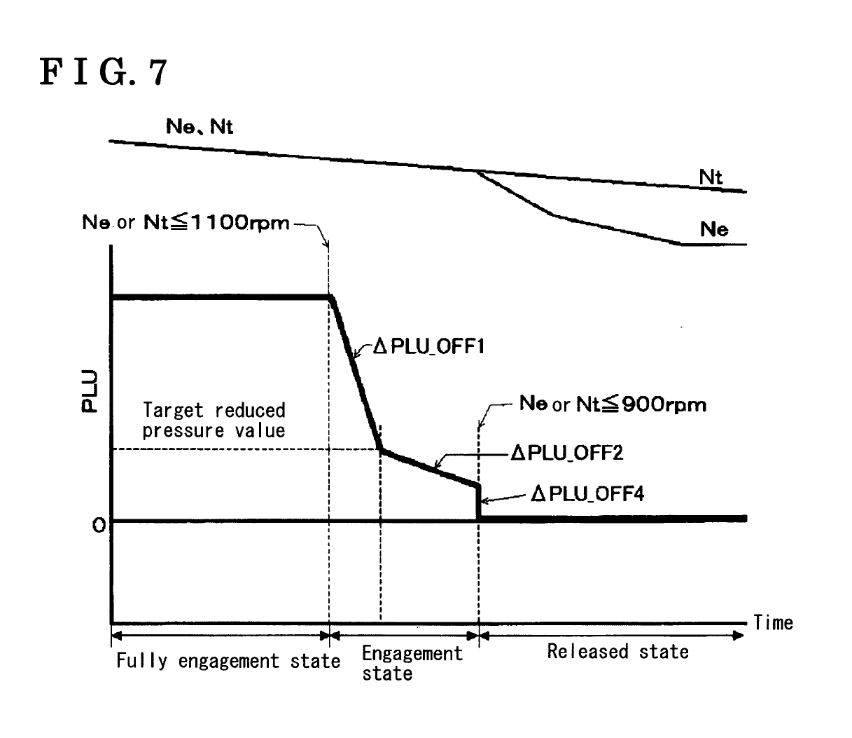

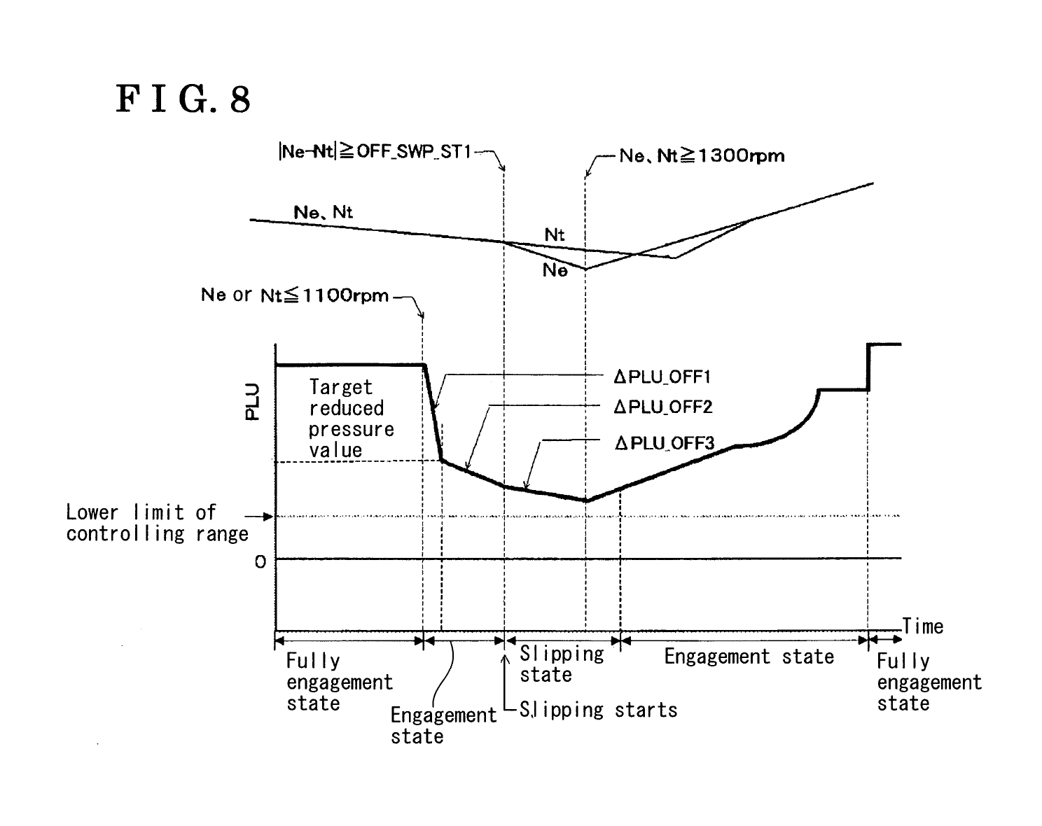

Next, operations of the control apparatus (electronic control unit) of the lockup clutch according to the first embodiment of the present invention are described hereinbelow with reference to FIGS. 5 to 8. The operations of the control apparatus of the lockup clutch are distinguished in four cases and each is explained with a corresponding drawing. FIG. 5 is a graph schematically illustrating a case (Case 1) of the operation of the control apparatus of the lockup clutch according to the first embodiment of the present invention. FIG. 6 is a graph schematically illustrating another case (Case 2) of the operation of the control apparatus of the lockup clutch according to the first embodiment of the present invention. FIG. 7 is a graph schematically illustrating still another case (Case 3) of the operation of the control apparatus of the lockup clutch according to the first embodiment of the present invention. FIG. 8 is a graph schematically illustrating still another case (Case 4) of the operation of the control apparatus of the lockup clutch according to the first embodiment of the present invention.

(Case 1) The case 1 is explained hereinbelow in a manner where the power unit rotation speed Ne or the first output shaft rotation speed Nt is equal to, or less than 1100 rpm (Ne, Nt≦1100 rpm) and further the lockup pressure PLU is greater than the target reduced pressure value (the lockup pressure PLU>the target reduced pressure value). With reference to FIG. 5, when the power unit rotation speed Ne or the first output shaft rotation speed Nt becomes equal to, or less than 1100 rpm (Ne, Nt≦1100 rpm), the electronic control unit (no. 50 in FIG. 1) reduces the lockup pressure PLU to the target reduced pressure value at the first pressure reduction speed ΔPLU_OFF1 in a manner where the lockup clutch is fully engaged. Here, when the lockup clutch is fully engaged, the lockup pressure PLU is a total pressure of an essential pressure and a margin pressure. The essential pressure is a minimum required pressure to engage the lockup clutch, i.e., to integrally rotate the first output shaft 31 and the second output shaft 32. Meanwhile the margin pressure is exerted in consideration of safety ratio and in order to maintain a rigid engagement of the lockup clutch. Then, when the lockup pressure PLU is less than the target reduced pressure value (the lockup pressure PLU>the target reduced pressure value) in a manner where a driver does not step on an accelerator nor suddenly steps on a brake, the electronic control unit (no. 50 in FIG. 1) reduces the lockup pressure PLU until the absolute rotational difference |Ne−Nt| becomes equal to, or exceeds, the predetermined rotational difference OFF_SWP_ST1 at the second pressure reduction speed APLU_OFF2 (|Ne−Nt|≧OFF_SWP_ST1). Then, when the absolute rotational difference |Ne−Nt| is equal to, or exceeds, the predetermined rotational difference OFF_SWP_ST1 (|Ne−Nt|≧OFF_SWP_ST1) in a manner where a driver does not step on an accelerator nor suddenly steps on a brake, the electronic control unit (no. 50 in FIG. 1) reduces the lockup pressure PLU with the third pressure reduction speed ΔPLU_OFF3.

(Case 2) The case 2 is explained hereinbelow in a manner where the power unit rotation speed Ne or the first output shaft rotation speed Nt is equal to, or less than 1100 rpm (Ne, Nt≦1100 rpm) and further the lockup pressure PLU is less than the reducing pressure target level (the lockup pressure PLU<the target reduced pressure value). With reference to FIG. 6, when each power unit rotation speed Ne or the first output shaft rotation speed Nt becomes equal to, or less than 1100 rpm (Ne, Nt≦1100 rpm) in a manner where the lockup clutch is being engaged, the electronic control unit (no. 50 in FIG. 1) reduces the lockup pressure PLU until the absolute rotational difference |Ne−Nt| becomes equal to, or exceeds, the predetermined rotational difference OFF_SWP_ST1 at the second pressure reduction speed ΔPLU_OFF2 (|Ne−Nt|≧OFF_SWP_ST1). Then, when the absolute rotational difference |Ne−Nt| is equal to, or exceeds, the predetermined rotational difference OFF_SWP_ST1 (|Ne−Nt|≧OFF_SWP_ST1) in a manner where a driver does not step on an accelerator nor suddenly steps on a brake, the electronic control unit (no. 50 in FIG. 1) reduces the lockup pressure OLU with the third pressure reduction speed ΔPLU_OFF3.

(Case 3) The case 3 is explained hereinbelow in a manner where the power unit rotation speed Ne or the first output shaft rotation speed Nt becomes equal to, or less than 900 rpm (Ne, Nt≦900 rpm). With reference to FIG. 7, when the power unit rotation speed Ne or the first output shaft rotation speed Nt becomes equal to, or less than 900 rpm (Ne, Nt≦900 rpm) by the driver suddenly stepping on the brake at the electronic control unit is reducing the lockup pressure PLU at the second pressure reduction speed ΔPLU_OFF2, the electronic control unit (no. 50 in FIG. 1) reduces the lockup pressure PLU at the fourth pressure reduction speed ΔPLU_OFF4.

(Case 4) The case 4 is explained hereinbelow in a manner where each power unit rotation speed Ne and the first output shaft rotation speed Nt becomes equal to, or exceeds 1300 rpm (Ne, Nt≧1300 rpm) and further the lockup pressure PLU becomes equal to, or exceeds the lower limit of the range at which the lockup pressure PLU can be controlled (the lockup pressure PLU≧the lower limit of the range). With reference to FIG. 8, when each power unit rotation speed Ne and the first output shaft rotation speed Nt becomes equal to, or exceeds 1300 rpm (Ne, Nt≧1300 rpm) by the driver stepping on the accelerator in a manner where the electronic control unit is reducing the lockup pressure PLU at the third pressure reduction speed ΔPLU_OFF3, the electronic control unit (no. 50 in FIG. 1) intensifies the lockup pressure PLU at the predetermined speed or at predetermined pattern.

According to the first embodiment, by reducing the lockup pressure to the target reduced pressure value at the disengagement manner of the lockup clutch, a time lag until the complete engagement manner of the lockup clutch is reduced. Accordingly, an uncomfortable engine vibration is reduced. This is because the electronic control unit rapidly reduces the lockup pressure to the target reduced pressure value at which a slip is not generated when the oil pressure, which is higher than the reducing pressure target level, is outputted.

When each power unit rotation speed Ne and the first output shaft rotation speed Nt is equal to, or exceeds, a predetermined rotation number at the lockup clutch is released, by discontinuing the release of the lockup clutch and then leading to engaging the lockup clutch, the frequency of the operation “on”/“off” of the lockup clutch is reduced. Further, a durability of the lockup clutch is effectively improved and an engine performance is protected from being lowered. This is because the electronic control unit detects that the disengagement of the lockup clutch is not necessary and discontinues the disengagement of the lockup clutch.

Further, the engine is prevented from high-rpm-idling by lowering a releasing gradient of the lockup clutch when the electronic control unit detects the slip of each rotation speeds Ne and Nt, and further more, the time lag, until the lockup clutch is completely released, is reduced. This is because the releasing gradient, when detecting the slip of each rotation speeds Ne and Nt, is lowered.

When the oil pressure is reduced until the lockup pressure PLU becomes uncontrollable during the lockup clutch 26 is being disengaged, a shock generated by a sudden engagement is prevented from being generated by prohibiting the lockup clutch 26 from being engaged when each rotation speeds Ne and Nt is equal to or exceeds the predetermined rotation number. This is because the electronic control unit sends a signal to reduce the lockup pressure PLU below a pressure applied to the lockup piston 29 of the lockup mechanism from the clutch-disengagement oil chamber R2 and accordingly, the oil pressure is not raised any further.

Additionally, when the power unit rotation speed Ne and the first output shaft rotation speed Nt is equal to, or less than, the predetermined rotation number, by operating the above-described movement without following a lockup area map, an “ON” area of the lockup clutch is optimized. This is because the lockup area map is determined at a non-gear-changing condition and when the gear is being changed, the lockup clutch is disengaged (“OFF”) in accordance with a requirement. In other words, conventionally, in view of avoiding that the uncomfortable engine vibration is felt by the driver when the lockup clutch is engaged in a manner where each power unit rotation speed Ne and the first output shaft rotation speed Nt has a low rotation speed (Ne, Nt is equal to, or less than, 1000 rpm, for example), an “OFF” area of the lockup clutch is determined higher such as the first output shaft rotation speed Nt is higher than 1500 rpm (Nt>1500 rpm). Further, the uncomfortable engine vibration is felt less by the driver at the non-gear-changing condition than at the gear changing condition because a gear ratio is not altered. Accordingly, the lockup area may be necessarily distinguished in accordance with the gear-changing condition and the non-gear-changing condition. However, the lockup area map determines various control modes such as heating-up mode, ABS mode, and so on according to all other modes. Therefore the lockup area map uses a large ROM storage and it may be difficult to additionally set the lockup area according to the gear changing condition and the non-gear-changing condition. Accordingly, the lockup area is set in order not to generate the uncomfortable engine vibration at the gear changing condition, and the lockup area is developed at non-gear-changing area. Further, at the non-gear-changing condition, the lockup area is narrowed and a fuel consumption and a driving force capacity are wasted in vain. Additionally, at the gear changing condition, the electronic control unit reduces the lockup pressure to the target reduced pressure value of the disengagement condition of the lockup clutch without following the “ON” area of the lockup clutch only when each power unit rotation speed Ne and the first output shaft rotation speed Nt has a low rotation speed. Therefore, substantially the “ON” area of the lockup clutch becomes wider. Accordingly, the lockup map is set at the non-gear-changing condition and on the other hand, at the gear-changing condition, the lockup clutch is disengaged (“OFF”) in accordance with the requirement, the “ON” area of the lockup clutch is optimized.

According to the control apparatus for the lockup clutch, as described above, it is preferable that the lockup pressure PLU is controlled to be reduced at the second pressure reduction speed ΔPLU_OFF2, which is lower than the first reduction speed ΔPLU_OFF1, until the lockup clutch starts slipping, when the lockup pressure PLU becomes equal to, or lower than, the target reduced value.

According to the above described subject matter, when the lockup clutch 26 is controlled with the oil pressure from the fully engagement state to the disengagement state, the oil pressure may be smoothly and stepwisely reduced. Accordingly, the lockup clutch 26 may be controlled to be disengaged without the high rpm idling of the power unit 10. In detail, generally when the lockup clutch 26 is in the fully engagement state, the lockup pressure PLU is composed with a total pressure of an essential pressure, which is required to integrally rotate the first output shaft 31 and the second output shaft 32, and a margin pressure, which is exerted in consideration of safety ratio and in order to maintain a rigid engagement of the lockup clutch. However, according to the present invention, the target reduced pressure value is assigned with an oil pressure around the essential pressure. Accordingly, the lockup pressure PLU is reduced at the first reduction speed ΔPLU_OFF1 with an amount of the margin pressure and further, the lockup pressure PLU is reduced at the second pressure reduction speed ΔPLU_OFF2, which is lower than the first pressure reduction speed ΔPLU_OFF1, until the lockup clutch 26 starts slipping. Therefore, according to the present invention, the lockup pressure is smoothly stepwisely reduced while conventionally the lockup pressure is reduced rapidly from the fully engagement state to the disengagement. Accordingly, a load applied to the motor 10 (engine) is prevented from rapidly reducing and the motor 10 (engine) is prevented from high rpm idling. Further, the lockup pressure PLU is reduced at the second pressure reduction speed ΔPLU_OFF2, which is lower than the first reduction speed ΔPLU_OFF1, until the lockup clutch 26 starts slipping, and accordingly the lockup pressure PLU is reduced at a reduction speed which is lower than the second pressure reduction speed ΔPLU_OFF2 until the lockup pressure PLU becomes zero, i.e., until the lockup clutch comes to the disengagement state.

It is further preferable that the lockup pressure PLU is controlled to be reduced at a third pressure reduction speed ΔPLU_OFF3, which is lower than the second pressure reduction speed ΔPLU_OFF2, when the lockup clutch 26 starts slipping.

According to the above described subject matter, the motor 10 (engine) is prevented from high rpm idling and a time lag, until the complete engagement manner of the lockup clutch, is reduced. This is because when the slipping of the lockup clutch 26 is detected, the releasing gradient of the lockup clutch 26 becomes lower.

It is still further preferable that the lockup pressure PLU is controlled to be reduced at a fourth pressure reduction speed ΔPLU_OFF4, which is higher than the first pressure reduction speed ΔPLU_OFF1, when the power unit rotation speed Ne or the first output shaft rotation speed Nt becomes equal to, or lower than a second rotation speed, which is lower than the first rotation speed.

According to the above described subject matter, the “ON” area of the lockup clutch may be optimized. This is because a lockup area map is determined at a non-gear-changing condition and when the gear is being changed, the lockup clutch is disengaged (“OFF”) in accordance with a requirement.

It is still further preferable that the lockup pressure PLU is controlled to be increased at the intensified pressure speed ΔPLU_UP when the power unit rotation speed Ne and the first output shaft rotation speed Nt becomes equal to, or exceeds, a third rotation speed, which is higher than the first rotation speed.

According to the above descrived subject matter, the frequency of the operation “on”/“off” of the lockup clutch 26 is reduced and a durability of the lockup clutch 26 is effectively improved. Further, an engine performance is protected from being lowered by controlling the lockup clutch 26 to be engaged. This is because the electronic control unit 50 detects that the disengagement of the lockup clutch 26 is not necessary and discontinues the disengagement of the lockup clutch 26.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A lockup clutch control apparatus, comprising:
a power unit;
an automatic transmission for transmitting a driving force generated by the power unit;
a torque converter arranged between the power unit and the automatic transmission;
an input shaft connected to the power unit for transmitting the driving force from the power unit to the torque converter;
a first output shaft connected to the automatic transmission for transmitting the driving force from the power unit to the automatic transmission via the torque converter;
a second output shaft connected to the automatic transmission for transmitting the driving force from the automatic transmission; and
a lockup clutch arranged with the torque converter and being shifted between a fully engaged state and a disengaged state;
wherein, when a power unit rotation speed or a first output shaft rotation speed is equal to, or lower than a first rotation speed, the lockup pressure supplied to the lockup clutch is controlled at a first pressure reduction speed to a target reduced pressure value where the lockup clutch still maintains an engaging state upon the lockup clutch being shifted from the fully engaged state to the disengaged state.

2. The lockup clutch control apparatus according to claim 1, wherein,
when the lockup pressure becomes equal to, or lower than, the target reduced value, the lockup pressure is controlled to be reduced at a second pressure reduction speed until the lockup clutch starts slipping, and the second pressure reduction speed is lower than the first pressure reduction speed.

3. The lockup clutch control apparatus according to claim 2, wherein,
when the lockup clutch starts slipping, the lockup pressure is controlled to be reduced at a third pressure reduction speed, and the third pressure reduction speed is lower than the second pressure reduction speed.

4. The lockup clutch control apparatus according to claim 1, wherein,
when the power unit rotation speed or the first output shaft rotation speed becomes equal to, or lower than a second rotation speed, the lockup pressure is controlled to be reduced at a fourth pressure reduction speed, and the second rotation speed is lower than the first rotation speed and the fourth pressure reduction speed is higher than the first pressure reduction speed.

5. The lockup clutch control apparatus according to claim 2, wherein,
when the power unit rotation speed or the first output shaft rotation speed becomes equal to, or lower than a second rotation speed, the lockup pressure is controlled to be reduced at a fourth pressure reduction speed, and the second rotation speed is lower than the first rotation speed and the fourth pressure reduction speed is higher than the first pressure reduction speed.

6. The lockup clutch control apparatus according to claim 3, wherein,
when the power unit rotation speed or the first output shaft rotation speed becomes equal to, or lower than a second rotation speed, the lockup pressure is controlled to be reduced at a fourth pressure reduction speed, and the second rotation speed is lower than the first rotation speed and the fourth pressure reduction speed is higher than the first pressure reduction speed.

7. The lockup clutch control apparatus according to claim 1, wherein,
when the power unit rotation speed and the first output shaft rotation speed is equal to, or exceeds, a third rotation speed, the lockup pressure is controlled to be increased, and the third rotation speed is higher than the first rotation speed.

8. The lockup clutch control apparatus according to claim 2, wherein,
when the power unit rotation speed and the first output shaft rotation speed is equal to, or exceeds, a third rotation speed, the lockup pressure is controlled to be increased, and the third rotation speed is higher than the first rotation speed.

9. The lockup clutch control apparatus according to claim 3, wherein,
when the power unit rotation speed and the first output shaft rotation speed is equal to, or exceeds, a third rotation speed, the lockup pressure is controlled to be increased, and the third rotation speed is higher than the first rotation speed.

10. The lockup clutch control apparatus according to claim 4, wherein,
when the power unit rotation speed and the first output shaft rotation speed becomes equal to, or exceeds, a third rotation speed, the lockup pressure is controlled to be increased, and the third rotation speed is higher than the first rotation speed.

11. The lockup clutch control apparatus according to claim 5, wherein,
when the power unit rotation speed and the first output shaft rotation speed becomes equal to, or exceeds, a third rotation speed, the lockup pressure is controlled to be increased, and the third rotation speed is higher than the first rotation speed.

12. The lockup clutch control apparatus according to claim 6, wherein,
when the power unit rotation speed and the first output shaft rotation speed becomes equal to, or exceeds, a third rotation speed, the lockup pressure is controlled to be increased, and the third rotation speed is higher than the first rotation speed.
